(19) United States
(12) Patent Application Publication
(10) Pub. No.: US 2009/0028000 A1
(43) Pub. Date: Jan. 29, 2009

(54) METHOD AND PROCESS FOR THE SYSTEMATIC EXPLORATION OF URANIUM IN THE ATHABASCA BASIN

(76) Inventor: Thomas B. O'Brien, Blaine, WA (US)

Correspondence Address: BROWN RUDNICK LLP, ONE FINANCIAL CENTER, BOSTON, MA, 02111, US

(21) Appl. No.: 12/179,866

(22) Filed: Jul. 25, 2008

Related U.S. Application Data
(60) Provisional application No. 60/962,084, filed on Jul. 26, 2007.

(51) Int. Cl. G01V 1/28

(52) U.S. Cl. 367/47

(57) ABSTRACT

A method for the identification of metallic deposits in a rock formation is provided. The method for the identification includes the steps of providing an acoustic source for generating frequencies to produce acoustic waves, arranging at least one geophone optimized to detect the frequencies and oriented to enhance reflection planes from faults and fractures associated with an ore body in a rock formation and locating the acoustic source and at least one geophone in at least one shallow bore hole beneath unconsolidated surface material of the rock formation. The method further includes the steps of directing the acoustic waves to an underlying rock formation to generate seismic reflection data and processing the seismic reflection data by altering the frequency and the amplitude to identify unique seismic attributes that allow detection of at least one metallic deposit or ore body in the rock formation.

### RELATED APPLICATION INFORMATION

This patent application claims priority of U.S. Provisional Application No. 60/962,084, filed in the U.S. Patent and Trademark Office on Jul. 26, 2007. The entire contents are incorporated herein by reference.

### FIELD OF THE INVENTION

The present disclosure relates generally to the exploration of uranium and more particularly to uranium exploration using seismic reflection methods.

### BACKGROUND OF THE INVENTION

Various methods are used in prospecting for uranium. Because of the high cost of drilling and coring, prospecting typically relies on geochemical surface sampling of erosion products or remote sensing techniques, including gravity and magnetic surveys that sometimes give clues to the presence of underlying ore. These “pre-drill” surveys help identify prospective areas to drill.

### SUMMARY OF THE INVENTION

The present disclosure relates to the use of seismic methods, including tunable sound sources, unique subsurface positioning of the sound source and sound detectors (geophones), and special sound processing techniques to enhance the subsurface image and interpretation. This methodology takes advantage of the special geologic attributes found in some of the world's richest uranium deposits—such as the unconformity type deposits found in the Canadian and Australian basins that make up more than one third of the known world uranium reserves. The Athabasca Basin in Saskatchewan Province of Canada is the site of the most concentrated deposits of uranium ore in the world.

Accordingly, a method, for the identification of metallic deposits in a rock formation is provided. The method for the identification of metallic deposits includes the steps of providing an acoustic source for generating frequencies to produce acoustic waves, arranging at least one geophone optimized to detect the frequencies and oriented to enhance reflection planes from faults and fractures associated with an ore body in a rock formation and locating the acoustic source and at least one geophone in at least one shallow bore hole beneath unconsolidated surface material of the rock formation. The method further includes the steps of directing the acoustic waves to an underlying rock formation to generate seismic reflection data and processing the seismic reflection data by altering the frequency and the amplitude to identify unique seismic attributes that allow detection of at least one metallic deposit: or ore body in the rock formation. The rock formation can include formations selected from quartzo-feldspathic sandstone, basal metamorphic and igneous rock, mineralogic alteration halos, and faults and fractures associated with ore bodies. Further, the metallic deposits can include uranium oxide. This method can further include the step of special processing the seismic reflection data by modulating frequency and amplitude filters of the seismic reflection data from the rock formation to optimize the detection of the metallic deposit or ore body.

In an exemplary embodiment, the method according to the present disclosure further includes the step of using the seismic attributes to identify ore bodies in an exploration area where the ore bodies have yet to be detected.

The acoustic source, according to the present disclosures can generate a range of frequencies including both high and low frequency acoustic waves. Further, the acoustic source can generate a range of frequencies that are substantially divergent. In one embodiment, the acoustic source and geophone are located in shallow wells beneath unconsolidated material at the surface of the rock formation.

In another embodiment, the method for detecting uranium oxide includes the steps of providing an acoustic source for generating a range of acoustic frequencies to a configured array of at least one geophone, directing the acoustic frequencies to an underlying rock formation to generate seismic reflection data, identifying key frequencies in the seismic reflection data from the test area to allow identification of an ore body, using the key frequencies to identify ore targets in an exploration area and verifying the presence of ore in the ore targets by analyzing at least one recovered sample for the presence of uranium oxide.

### BRIEF DESCRIPTION OF THE DRAWING

Various exemplary embodiments of the present invention will be described in detail, with reference to the following FIGURE, wherein:

FIG. 1 is a schematic diagram of the method and process for identifying and locating uranium and associated ore minerals using the seismic reflection methods described according to the present disclosure.

### DETAILED DESCRIPTION

The present disclosure relates to the location of uranium deposits using the physical properties associated with the deposits using seismic reflection techniques uniquely suited to uranium deposits. The methodologies according to the present disclosure help establish the specific seismic signature of deposits in an area with known economic uranium ore and then, using these criteria, apply the technique to an exploration area to find ore bodies. The method according to the present disclosure may be applied to rock formations having a variety of materials present including quartzo-feldspathic sandstone, basal metamorphic and igneous rock, mineralogic alteration halos, and faults and fractures associated with ore bodies.

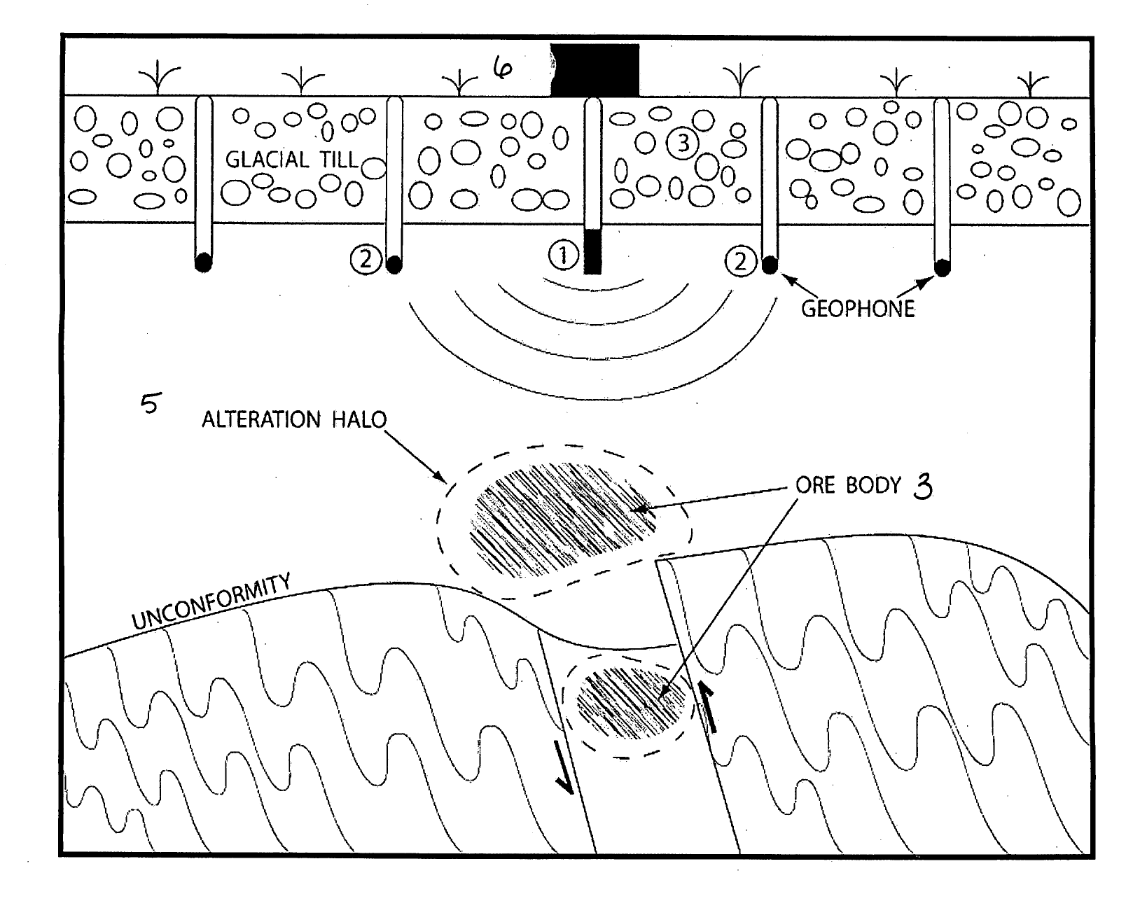

The best example that illustrates the nature of the unconformity-type deposits is found in the Athabasca basin of Canada, for example, as illustrated in FIG. 1. Typically, these uranium deposits occur beneath 30-40 meters of unconsolidated glacial till at depths up to 1500 meters near the unconformity between Pre-Cambrian metamorphic basement and overlying Pre-Cambrian siliciclastic sandstones. Faults and associated fractures are a key feature to the uranium occurrences because they provide pathways for hot, uranium-bearing solutions to move into the sandstones. These faults typically have a predictably orientation that is determined by the regional stress field. This relationship allows an advantageous positioning of geophones for imaging of the faults. The hot fluids characteristically alter the sandstone by leaching quartz and precipitating quartz and clay minerals (illite, kaolinite, and chlorite) as the solutions cool. The uranium is typically found in the core of the alteration halo, either within the basement fault close to the unconformity or within the overlying sandstone near the fault along the unconformity. Several other associations include the presence of graphitic pelitic schist (metamorphosed organic shale) and granitoid rocks in the basement (both rich in uranium), and the occurrence of the uranium deposits in topographic lows along the unconformity.

The uranium ore occurs in concentrations of up to 30% uranium oxide, but concentrations as low as a few percent can be economic. Because the uranium is associated with numerous characteristic indicators and each of these has special geophysical signatures (density and velocity contrasts, oriented acoustic interfaces), the present disclosure relates to seismic methods to take advantage of these characteristics for uranium detection of the ore bodies.

These pods, or ore bodies, of concentrated metallic compounds sometimes contain uranium oxides in concentrations as high as 58% U₃O₈, uranium oxides. Geophysical methods using gravity and density anomalies are not as effective as one may assume owing to the “massive” nature of the igneous and metamorphic basement rocks.

The pods containing uranium can be economic, due to the high concentration, in very small volumes, as little as 10,000 cubic meters. Thus, finding them is akin to finding “a needle in a haystack”. The use of seismic geophysical techniques seems to be ideal due to the strongly anomalous nature of these deposits vis-à-vis the contrasting seismic velocities (related to rock density) and planar acoustic interfaces. Due to the relatively shallow depths of 100 to 300 meters, which are desirable for economic exploitation, a relatively high frequency seismic regime would be ideal. Higher frequency sound sources would be needed with the geophone arrays and processing systems tailored for this express use. Conventional land seismic used in oil and gas exploration is predominantly aimed at depths of 1000 to 4000 meters and deeper and uses the lower frequencies that penetrate to great depths. This analysis is designed to determine stratigraphy and structure. According to the present disclosure, higher frequencies will enhance the detail of shallow subsurface features during uranium prospecting.

The method according to the present disclosure employs unconventional sound sources as well as seismic data processing methods in order to select these anomalies. The proper frequencies and wavelengths can be determined by running this high frequency system over spent or current mines of the type described and then filtering and modulating the data to a point where the sought-after deposition “signature” becomes apparent. Once the proper input, output, and processing is found in order to develop a characteristic “signature,” the process can be performed over exploration land in order to find the same “signature.”

The dramatic density difference between the basement rock, the overlying sandstone, the alteration halo, and the ore body itself should create a sufficient visual anomaly to locate these pods of metallic compounds. However, it will call for sophisticated enhancements of conventional seismic processing. The use of high and low cut frequencies that are substantially divergent may be necessary. Therefore, it would be ideal to run the system over an existing or depleted mine to get a clear “signature.” A significant part of the present disclosure is determining the processing parameters that allow distinguishing between uranium ore bodies and rock background. An analog of this would be the “bright spot” found in hydrocarbon deposits that differentiates between natural gas and oil. This methodology should drastically reduce the number of “trials” necessary in what is largely now a “trial and error” process.

Accordingly, the present disclosure relates to a method to locate uranium deposits from the physical properties associated with the deposits using seismic reflection techniques uniquely suited to uranium deposits. The present disclosure describes methods used to establish the specific seismic signature of said deposits in an area with known economic uranium ore and then using these criteria apply the technique to an exploration area to find ore bodies as shown in FIG. 1.

FIG. 1 is a schematic diagram of a rock formation and the methods for identifying and locating uranium and associated ore minerals using the seismic reflection methods described herein. An acoustic: source for generating a wide range of frequencies to produce acoustic waves is shown at 1. Generally, the acoustic source can generate a range of frequencies including both high and low frequency acoustic waves. Further, the acoustic source can generate a range frequency acoustic waves that are substantially divergent.

Geophones 2 are arranged in an array are optimized to detect frequencies and are oriented to enhance reflection planes from faults and fractures associated with the ore body shown at 3. Both the acoustic source and the geophone are located in shallow bore holes or wells beneath the unconsolidated surface material. For Canadian deposits this would be at the base, of the glacial till. At 5, acoustic waves are directed to the underlying rock formation to generate seismic reflection data. The seismic reflection data is processed at 6 by altering the frequency and amplitude to identify the unique seismic attributes that allow detection of the metallic deposit (including uranium) in the rock formation.

The method recited can further include the step of using discovered seismic attributes to identify ore bodies in an exploration area where ore bodies have yet to be detected. Additionally, special processing of the seismic data by modulating frequency and amplitude filters of the data from the rock formation to optimize the detection of the ore body may be implemented.

In another embodiment, the method according to the present disclosure includes the step of providing an acoustic source for generating a range of acoustic frequencies to a configured array of geophones and the acoustic waves are directed to the underlying rock formation to generate seismic reflection data. Further, key frequencies in the seismic data from the test areas allow identification of the known ore body are also identified. These key frequencies can be used to identify ore targets in an exploration area. Once ore targets are identified, the presence of the ore in the targeted area can be verified by analyzing the recovered samples for the presence of uranium oxide.

What is claimed is:

1. A method for the identification of metallic deposits in a rock formation, the method comprising the steps of:
providing an acoustic source for generating frequencies to produce acoustic waves;
arranging at least one geophone optimized to detect the frequencies and oriented to enhance reflection planes from faults and fractures associated with an ore body in a rock formation;
locating the acoustic source and the at least one geophone in at least one shallow bore hole beneath unconsolidated surface material of the rock formation;
directing the acoustic waves to an underlying rock formation to generate seismic reflection data; and
processing the seismic reflection data by altering the frequency and the amplitude to identify unique seismic attributes that allow detection of at least one metallic deposit or ore body in the rock formation.

2. A method as recited in claim 1, further comprising the step of using the seismic attributes to identify ore bodies in an exploration area where the ore bodies have yet to be detected.

3. A method as recited in claim 1, wherein the metallic deposit includes uranium oxide.

4. A method as recited in claim 1, wherein the acoustic source generates a range of frequencies including both high and low frequency acoustic waves.

5. A method as recited in claim 1, wherein the rock formation includes formations selected from quartzo-feldspathic sandstone, basal metamorphic and igneous rock, mineralogic alteration halos, and faults and fractures associated with ore bodies.

6. A method as recited in claim 1, wherein the acoustic source generates a range of frequency acoustic waves that are substantially divergent.

7. A method as recited in claim 1, wherein the acoustic source and at least one geophone are located in shallow wells beneath unconsolidated material at the surface of the rock formation.

9. A method as recited in claims 1, further comprising the step of special processing the seismic reflection data by modulating frequency and amplitude filters of the seismic reflection data from the rock formation to optimize the detection of the metallic deposit or ore body.

10. A method for detecting uranium oxide, the method comprising the steps of:
providing an acoustic source for generating a range of acoustic frequencies to a configured array of at least one geophone;
directing the acoustic frequencies to an underlying rock formation to generate seismic reflection data;
identifying key frequencies in the seismic reflection data from the test area to allow identification of an ore body;
using the key frequencies to identify ore targets in an exploration area; and
verifying the presence of ore in the ore targets by analyzing at least one recovered sample for the presence of uranium oxide.
